(19) United States
(12) Patent Application Publication
(10) Pub. No.: US 2002/0095367 A1
(43) Pub. Date: Jul. 18, 2002

(54) Competitive access video/audio monitoring system

(76) Inventors: Ichiro Mizunuma, Tokyo (JP); Ichiro Masaki, Boxborough, MA (US)

Correspondence Address: LEYDIG VOIT & MAYER, LTD, 700 THIRTEENTH ST. NW, SUITE 300, WASHINGTON, DC, 20005-3960, US

(21) Appl. No.: 09/761,648

(22) Filed: Jan. 18, 2001

(51) Int. Cl. G06F 17/60

(52) U.S. Cl. 705/37

(57) ABSTRACT

A system for competitively allocating video and/or audio resources of a server includes a server receiving and processing at least one of video and audio information and producing at least one output, all outputs of the server together not exceeding resources of the server in terms of at least one of a maximum frame rate, a maximum resolution, and a maximum bit rate, the server including a bid table for recording client bids and an auction thread for evaluating competing client bids with regard to resources requested and price; a network connected to the server; and a plurality of clients connectable to the network and requesting, from time-to-time, access to the at least one of video and audio information and specifying desired resources including at least one of frame rate, resolution, and bit rate, and a bid price for the resources specified, the server responding to each client request by establishing a server thread for each client for supplying requested video and/or audio information, ordering the bids in the bid table according to a priority based on price and desired resources specified, and through the auction thread, by allocating resources requested by clients supplying bids in a decreasing order of the priority until all of the resources have been allocated to clients specifying desired resources and a bid price.

### FIELD OF THE INVENTION

The invention pertains to an audio/video monitoring system having limited data transmission capacity and in which clients may compete for allocations of parts of that data transmission capacity. Such a system may be used to supply traffic information.

### BACKGROUND OF THE INVENTION

Many kinds of systems exist providing streams of video and/or audio information from centralized server computers. For example, TV cameras fixed in location may supply a video picture of a particular area. The video camera may move in order to provide a large area of coverage. Numerous cameras at different locations may supply video information that is sequentially delivered to viewers or that, in an interactive system, can be selected by a viewer. In addition, audio information may be supplied for some or all of the video information that is produced.

In addition to fixed video and/or audio monitoring systems, such systems can be employed on movable platforms. For example, public agencies and news organizations may provide video and/or audio information from an airborne platform, such as a helicopter or fixed wing aircraft, of newsworthy events as the events occur.

While video and/or audio information may be supplied from these sources through a fixed transmission system, such as a cable television network or a particular television channel, the same information can be supplied over the internet so that viewers in various locations can select a video and/or audio stream of interest. Supplying this information over the internet provides an opportunity for interaction between the user, i.e., viewer, and the video and/or audio source. However, the server providing the video and/or audio stream over the internet has limited computer and/or networking capacity. Therefore, the number of requests for the video and/or audio information may exceed the computing and/or networking capacity. For example, in a traffic monitoring system, when an accident or other incident occurs within range of a fixed or mobile camera, many users may wish to access the stream of video information concerning the accident or other incident. In current systems, no provision is made for giving priority to those viewers who have a particular need or interest in receiving the video and/or audio stream. For example, in a highway accident, public authorities, such as police and fire, may need to be given higher priority over drivers having vehicles equipped to receive internet video and/or audio information and over viewers at fixed locations.

Even if the operator of server supplying video and/or audio streams over the internet has the ability to assign computing and network resources for identified requests according to a system of priorities among requests for the video and/or audio streams, real time allocation of these resources by an individual presents difficult administrative problems for the server operator.

### SUMMARY OF THE INVENTION

It is an object of the invention to allocate limited computer and networking resources of a network to persons desiring access to the network on a competitive basis.

It is a further object of the invention to provide access to video and/or audio streams in a network to users based upon competitive bidding by the users.

It is a still further object of the invention to prioritize access requests by users for limited server and networking resources based upon user qualifications.

It is another object of the invention to provide a business method in which an agency, such as a highway management authority, permits a private organization to install video and/or audio information gathering devices on the property controlled by the authority, to sell the video and/or audio information that is gathered to other parties, based on bidding, while providing the information to the authority without charge and with highest priority.

In an embodiment of the invention, a system for competitively allocating video and/or audio resources of a server comprises a server receiving and processing at least one of video and audio information and producing at least one output, all outputs of the server together not exceeding resources of the server in terms of at least one of a maximum frame rate, a maximum resolution, and a maximum bit rate, the server including a bid table for recording client bids and an auction thread for evaluating competing client bids with regard to resources requested and price; a network connected to the server; and a plurality of clients connectable to the network and requesting, from time-to-time, access to the at least one of video and audio information and specifying desired resources including at least one of frame rate, resolution, and bit rate, and a bid price for the resources specified, the server responding to each client request by establishing a server thread for each client for supplying requested video and/or audio information, ordering the bids in the bid table according to a priority based on price and desired resources specified, and through the auction thread, by allocating resources requested by clients supplying bids in a decreasing order of the priority until all of the resources have been allocated to clients specifying desired resources and a bid price.

### BRIEF DESCRIPTION OF THE DRAWINGS

FIG. 1 is a schematic diagram of a system according to an embodiment of the invention.

FIG. 2 is an example of a bid table according to an embodiment of the invention.

FIG. 3 is a flow chart illustrating operation of an auction thread according to an embodiment of the invention.

FIG. 4 is a flow chart of a client process for minimizing a bid.

### DETAILED DESCRIPTION OF PREFERRED EMBODIMENTS

The method and apparatus described below are exemplary of a system for supplying, over a network to at least some of a large number of potential clients, video and/or audio information gathered at a site remote from the clients. Particular examples of such systems include traffic monitoring systems in which TV cameras may be installed at numerous locations along a highway for monitoring particular segments of the highway or particularly sensitive areas of a highway system, such as bridges and tunnels. Usually, in such installations, audio information is less useful than video information. The video cameras may be variable in resolution and in area covered, both with regard to zooming and remote aiming of the television camera. In other installations, it may be more important to gather audio information than video information. In still different locations, both audio and video information may be gathered with a TV camera and a microphone, for example, at a sporting event, performance, or academic activity.

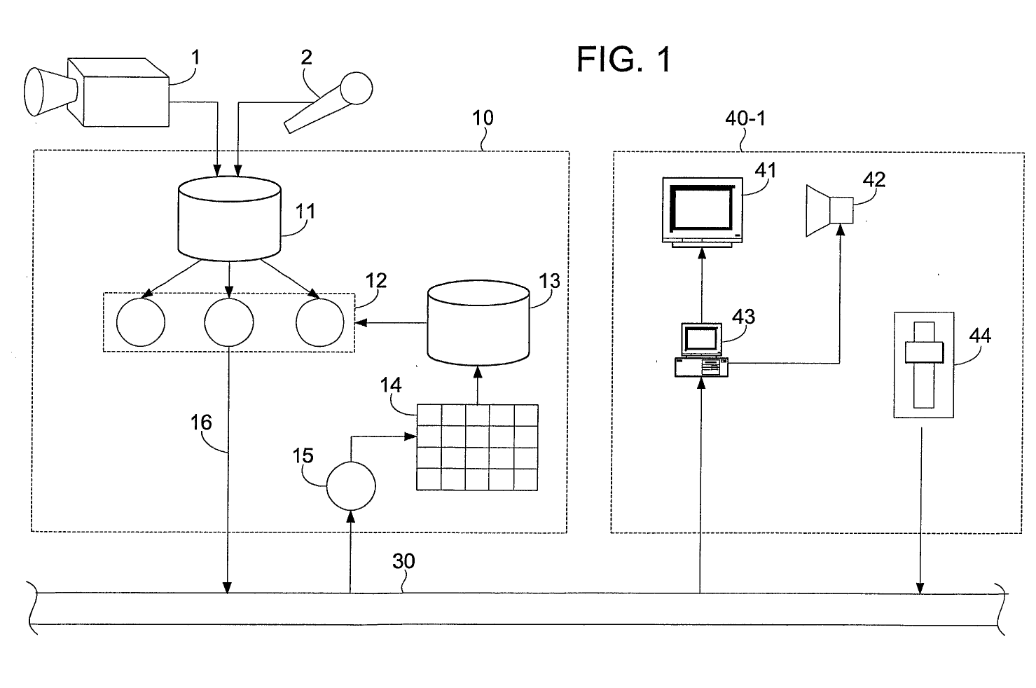

A system for gathering and distributing such information over a network, such as the internet, to which a wide variety of clients at remote, even world wide, locations may subscribe, is schematically illustrated in FIG. 1. The system illustrated includes three principal parts, in addition to the information gathering equipment, i.e., a television camera 1 and a microphone 2. The three principal parts of the system are a server 10, a network 30 connected to the server, and plurality of clients 40-1, 40-2 . . . 40-n. These clients may connect to the network 30 in order to gain access to the server 10. Only one such client, client 40-1, is shown in detail, but each of the clients 40-1 through 40-n is identical in the parts that are pertinent to the invention.

Within the server 10, an image/audio file 11 receives the video and/or audio information gathered by the TV camera 1 and the microphone 2. This raw information is processed into digital form and stored, at least temporarily, in a large memory for distribution to clients who request the information and qualify for its supply. Within the server 10 and supplied by the file 11 are a plurality of server threads, generally indicated by reference number 12. As explained below, each of the server threads is established in response to an inquiry, i.e., a request or connection, from a client. The server threads are employed to supply video and/or audio information to the client if the client qualifies based upon the competitive bidding for the resources of the server 10. As used in this description, the term “thread”, commonly used with respect to computer programs, means a program that is executed using available computing resources. In the invention, each thread is a part of a computer program that provides overall control for the server 10.

The information rate transmission resources of the server 10 are limited according to the construction of the server. Put another way, the server is able to supply only a finite amount of information per unit time. With regard to video information, which is the more demanding information in terms of information rate, the resources can be expressed either in bit rate or in terms of number of frames per second at a particular resolution. By reducing resolution and frames per second to one or more clients, the bit rate for those clients can be reduced so that the resources of the server 10 can be taxed less, making resources available for other clients. In other words, fewer clients can be supplied with video information at the maximum available resolution and frame rate than can be supplied at a minimum resolution and frame rate. An intermediate number of clients can be supplied with the same video information if some clients are supplied with the highest frame rate and resolution images while others are supplied with a lower frame rate and/or lower resolution images.

In order to provide access to the video and/or audio information from the server 10 to the largest number of clients consistent with the clients' needs and degree of interest, in the invention, the clients bid competitively for access to the information through the network 30. The server 10 includes an auction thread 13 and a bid table 14 to implement the bidding process. The network 30 accesses the server 10, when making a request for video and/or audio information, through a bid thread 15. The requested video and/or audio information, when a client qualifies to receive the information at a particular bit rate, is supplied through a network connection 16.

Each client, for example, client 40-1, includes an image display 41, such as a conventional cathode ray tube or flat panel display. The client may also include a sound producing element, such as a loudspeaker 42, for producing audio supplied from the server in response to a request. Within the client 40-1, a computer 43 receives a digital stream of information and decodes that information so that the information is supplied in an appropriate form to the display 41 and/or the speaker 42 to provide the desired video and/or audio information to the client. The client also includes a bid input means 44 for supplying a bid along with a request to the server 10. That input means 44 may be a keyboard through which an operator enters bid information, as described below. The input means may also be a graphical user interface in which the intended bid is indicated by selecting an icon or a position of an indicator on a display using an input selecting means such as a mouse.

The operation of the system is most easily explained by an example based upon a request from the client for video and/or audio information from the server 10. Using the input means 44, a bid is formulated at a particular information rate from the server 10. The bid is made as a bid price in combination with the specification of the level of resources desired by the client to be allocated to the client. For example, the client specifies, for video, a frame rate and resolution that is desired to be received. The client connects to the server 10, for example, through the internet and an internet service provider (ISP), and makes access to the bid thread 15. Each bid uniquely identifies the client making the bid, with a client ID that may be an internet address, and includes a bid price and a specification of the resource allocation desired. That information is then entered into a bid table 14.

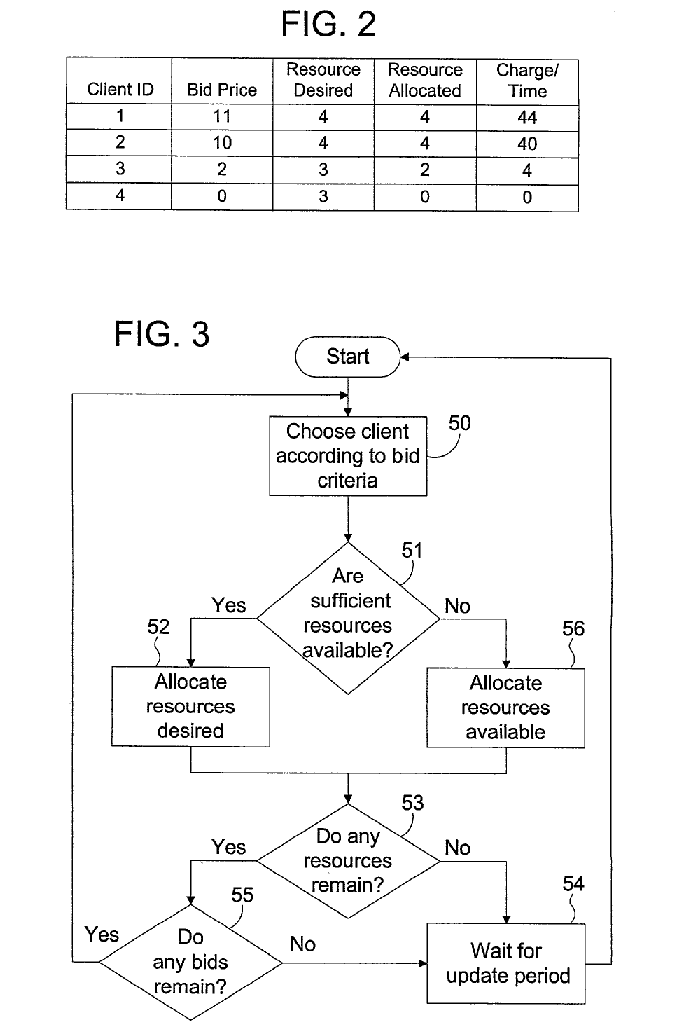

An example of a bid table 14 is shown in FIG. 2 as containing four bids from different clients. Each bid includes an identifier uniquely identifying the client, a bid price, and a specification of the resource allocation desired by the client. As shown in Table 2, clients may bid various prices for the resource allocation desired. The entries in Table 2 are hypothetical and illustrative without the specification of any units with regard to price or resources desired. The entry 4 in the third column of Table 2 may indicate the maximum resources ever allocated to any client, i.e., the maximum resolution and frame rate with respect to video information. A resource allocation of 3 in the third column of Table 2 indicates a lower bit rate that would be accepted by the client, e.g., a reduced video resolution and/or frame rate.

The bid thread arranges the bid table in a particular order, for example, by bid price. In this example, each bid is different so that there is no conflict nor ambiguity in arranging the bids according to bid price. Where identical bids are submitted in terms of price and resource allocation desired, the bids may be ordered based upon secondary considerations, such as the relative times at which the bids are received. Likewise, the resource allocation requested may be employed as a primary or secondary consideration in establishing the order of the bidding table. In this system, a client is charged an amount based upon the bid price and the resources actually allocated to the client. For example, the price charged per unit time is the product of the bid price and the resources actually allocated. Therefore, two bids having the same bid price but differing in desired resource allocation may be ordered with the higher desired resource allocation first since the potential revenue, if the desired resource allocation is achieved, will be higher from that client.

The example described suggests that all bids are received simultaneously, allowing the formation of the bid table. In fact, different bids are received at different times so that periodically the bid table is updated in response to the most recently received bids, which may include cancellation of a prior bid, amendment of a prior bid, or receipt of a new bid. For each bid table that is established, the auction thread 13 compares the bids of the table to the resources available for the server threads and allocates those resources according to the bids.

In a typical example, referring to FIG. 1, the resources available from the server may total, in resource units, ten. After prioritizing the bids, the auction thread first ensures that the highest priority bid receives all of the requested resource allocation. That highest priority bid in the example of FIG. 2 is the highest price bid and requests an allocation of four units which is assigned to the server thread connected to the network 30 and supplying the client responsible for that bid. The second highest price bid also requested four units of resources. Since six units remain, the requested four units are assigned to the second highest price bid through the server thread connected to the network that supplies the requested information to the client responsible for the second highest bid. The third highest price bid requests three units of resources. However, only two units remain within the total capacity of the server. Thus, the third requesting client is supplied with resources but at a level lower than requested. Finally, the fourth bid from a client user not willing to pay at all for the information finds no resources remaining and, therefore, is denied access to the requested information.

The situation illustrated by Table 2 is simply exemplary and does not limit the scope of the invention. Other arrangements for distributing available resources can be established by the auction thread. While, in the illustrated example, the second highest price bid receives the same resources at a lower price than the highest bid, a different priority in allocating the resources might be applied, for example, if more non-zero bids are made or if price is not the primary bid priority criterion. For example, the revenue generated per unit time by the product of the bid price and the allocated resources might be employed to prioritize the bids in order to maximize revenue while still giving the largest payers the most resources. For example, if an additional bid were made with a price of one, supplying the client submitting that bid with some resources withdrawn from the second bid might increase revenue. In other words, while it may be desirable to provide to the client submitting the highest price bid the full amount of resources requested, the specific example provided is not exclusive with respect to other arrangements of allocating the limited resources of the server to maximize income or achieve another goal, e.g., serving the maximum number of clients simultaneously. Likewise, when the information gathered by the TV camera concerns an accident or emergency requiring response by public authorities, public authorities may be given special identifications that preempt other clients regardless of price bid so that the authorities can monitor a dangerous situation and provide an appropriate response.

FIG. 3 is a flow chart illustrating one example of operation of the auction thread. In a first step 50, at the beginning of a time period allowed for entry of new bids and alteration or retraction of old bids in the bid table 14, a first bid is selected based upon a prioritization criteria, such as highest price bid, highest price bid and earliest entry, highest value based upon the product of bid price and resources requested, public authority clients preempting all other clients, or some other criterion. In step 51, it is determined whether sufficient resources are available to meet the level of resources desired and requested by the bid selected. If adequate resources are available, then, in step 52, the resources desired are allocated to the client making the selected bid. After making that allocation, in step 53, it is determined whether the resources of the server 10 have been exhausted. If there are no further resources available, at step 54, the auction thread pauses and waits for the passage of the time until the bids present in the bid table at the end of that time period are again evaluated. If, at step 53, it is determined that additional resources of the server are still available and not yet allocated, the process passes to step 55 where it is determined whether more bids remain in the bid table. If no more bids are present, the process is ended for this iteration and passes to step 54, waiting for the next action in response to an updated bid table.

If there are more bids to be considered, then the process returns to step 50 to the next bidder in the table, the bid table having been arranged based upon a prioritization already applied as bids have been received. At step 51, as the resources of the server 10 have been previously assigned, a condition may be reached at which the resources requested by a bidder cannot be fulfilled. In that event, the process passes to step 56 in which such resources as remain available are assigned to the bidder then being considered. At step 53, since there are no more resources available, the process passes to step 54, waiting for the next iteration. While the example provided assumes that all resources will be allocated because of the number of clients requesting information from the server 10, in some instances, all of the resources will not be allocated and each of the bidders will be supplied with some resources, i.e., video and/or audio data, either with the resources desired and requested or with approximately those resources.

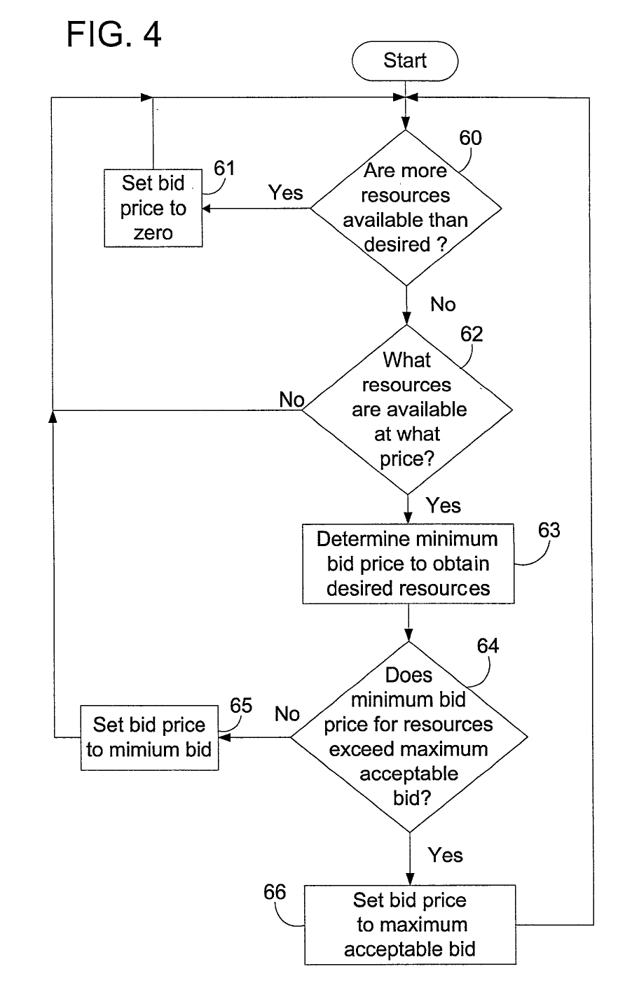

In the bid table of FIG. 2, the lowest ranking bid is a bid without any price. This bid is from a client that is interested in viewing or listening to the information that is being collected by the server 10 but unwilling to pay for the information. That client might be, in some circumstances, willing to pay a variable price for the requested information, not to exceed a maximum price, and preferably to receive the requested information free. That client may implement a variable bid employing a program, rather than a fixed bid. An example of such a variable program bid is illustrated in the flow chart of FIG. 4. Once such a program bid is submitted, in its first step 60, the program bid determines whether any of the server resources are unused after fulfilling the requests of other bids. If so, the program bid sets its price at zero in step 61 and awaits the next update of the resource allocation with the assurance that sufficient resources are available and will be allocated to the client making the program bid. If, at step 60, it is determined that any resources available are insufficient for the client making the program request, then, in test 62, a determination is made as to what resources are available at what bid price. Test 62 requires a search of the bid table 14 and an analysis of at least the lowest existing bids. With knowledge of the analysis technique employed by the auction thread to allocate resources, in step 63, a calculation is made to determine the minimum bid price required in order to obtain the resources desired by the client submitting the program bid. Then, in test 64, a determination is made as to whether the minimum bid required to obtain the desired resource allocation exceeds a maximum that the client submitting the program bid is willing to pay. If the calculated bid is less than the maximum acceptable bid, then, at step 65, the bid of the client submitting the program bid is established at the price calculated in step 63. At that bid, the client submitting the program bid can be assured of obtaining the desired resources at a price the client is willing to pay, provided other better bids are not received in the time period before the auction thread reviews the updated bid table to make an updated resource allocation. If, on the other hand, at test 64, a determination is made that the desired resources cannot be achieved without entering a bid at a price higher than the maximum price, at step 66, the client's bid is established at the maximum price. Then, when the auction thread next examines the bid table, it may allocate some, but not all, of the resources desired by the client unless, in the interim before the operation of the auction thread, higher priced bids are cancelled.

While the server 10 has been described as including a single television camera 1 and single microphone 2, a single server may process video and/or audio data from numerous video and/or audio sensors and client requests may pertain to one or more of those sensors. The server 10 receiving information from more than one sensor may require more computing and network capacity than a server receiving information from a single video and/or audio sensor. More complex resource allocation processes may be required than those described here but, preferably, separate bid threads, bid tables, and auction threads are provided for each sensor or group of sensors receiving video and/or audio data from a single source or incident.

A particular, but not limiting, application of the invention includes a public highway that may be operated by a public or private highway authority. In that application of the invention, the authority may itself install video and/or audio gathering equipment at various points along the highway. Alternatively, the authority may agree with a private entity for the installation of the video and/or audio gathering equipment and the associated hardware and software for implementing the invention. In the latter event, in order to pay for the equipment, its installation, and its operation, the private entity may sell the video and/or audio information gathered to private clients who competitively bid, according to the invention, to obtain that information. It is contemplated that in this application of the invention, the authority operating the highway would be given access to the information gathered either at low cost or at no cost, i.e., without regard to a bid, and with highest priority, at least in instances requiring emergency response.

The invention has been described with respect to certain preferred embodiments. However, the invention is not limited to those embodiments but is defined solely by the following claims which encompass all variations, additions, and equivalents within the express scope and spirit of the invention as described.

1. A system for competitively allocating video and/or audio resources of a server comprising:
a server receiving and processing at least one of video and audio information and producing at least one output, all outputs of the server together not exceeding resources of the server in terms of at least one of a maximum frame rate, a maximum resolution, and a maximum bit rate, the server including a bid table for recording client bids and an auction thread for evaluating competing client bids with regard to resources requested and price;
a network connected to the server; and
a plurality of clients connectable to the network and requesting, from time-to-time, access to the at least one of video and audio information and specifying desired resources including at least one of frame rate, resolution, and bit rate, and a bid price for the resources specified, the server responding to each client request by
establishing a server thread for each client for supplying requested video and/or audio information,
ordering the bids in the bid table according to a priority based on price and desired resources specified, and
through the auction thread, by allocating resources requested by clients supplying bids in a decreasing order of the priority until all of the resources have been allocated to clients specifying desired resources and a bid price.

2. The system according to claim 1 wherein the client supplying the highest bid price is given highest priority to the resources and before resource allocations to other clients.

3. The system according to claim 1 wherein the client supplying the bid having the highest product of bid price and desired resources is given highest priority to the resources and before resource allocations to other clients.

4. The system according to claim 1 wherein the bid table is updated in response to new and changed bids from clients, and the auction thread reassigns the resources available in response to each update of the bid table.

5. The system according to claim 1 wherein the client supplies a bid variable in bid price and desired resources to obtain an allocation of resources at a minimum cost.

6. The system according to claim 5 wherein the client specifies a maximum price payable for allocated resources and foregoes resource allocation if all resources have been allocated at bid prices exceeding the maximum price.

7. The system according to claim 1 wherein a client specifies a bid price as a minimum bid price based upon available resources to ensure access to the video and/or audio information unless a maximum bid price is exceeded.

8. The system according to claim 1 wherein specified clients are always given highest priority and are supplied with requested resources regardless of bid price.
